(19) United States
(12) Patent Application Publication
(10) Pub. No.: US 2006/0271788 A1
(43) Pub. Date: Nov. 30, 2006

(54) Access method for wireless authentication login system

(76) Inventors: An-Sheng Chang, Taipei Hsien (TW); Tai-Chuan Mao, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/135,505

(22) Filed: May 24, 2005

(51) Int. Cl. H04L 9/00

(52) U.S. Cl. 713/182

(57) ABSTRACT

An access method that a user can use to log into a computer system via a wireless authentication device. The access method includes: the wireless authentication device enters within the sensing range of an authentication module of the system. The authentication module of the system senses the wireless authentication device and generates access request message. The authentication module transmits an authentication request message to the wireless authentication device. The authentication module receives a set of access codes from the wireless authentication device. An authentication procedure is processed, allowing the system to be accessed by the user.

### BACKGROUND OF THE INVENTION

1. Field of the Invention

The present invention relates to an access method for a wireless authentication login system, and particularly relates to an access method for a wireless authentication login system that requires a user to login to a system by following a registration procedure via a wireless authentication device.

2. Description of Related Art

To ensure the security of an information system, such as content on a computer, a web page or web equipment, conventional methods, such as name and access codes set in advance or various biometrics verification manners including fingerprint or iris scans, are used throughout the information security industry. The most common method is giving a set of name and access codes for registering multi-users on an operation system. A user is only given access to the information they are allowed access to after the verification of his or her name and access codes.

Referring to FIG. 1, which is a standard login page according to a conventional login system of Microsoft Windows is illustrated. A username can be selected or typed in, for example, the system manager, a first user, a second user and other similar usernames. After that, the corresponding access codes must be typed in by the user so that they can gain further access.

U.S. Pat. No. 5,671,354 discloses a user access method to a network system via a username and an access code. U.S. Pat. No. 6,487,622 discloses a method of authenticating and accessing a biometric file security system, but the capacity to identify a large number of people is heavily restricted. In addition, the biometric file securing system is too expensive to be used by the general public.

In view of the complications of conventional login methods, a new, simplified procedure according to the present invention is provided to allow a user rapid, easy and secure access to information systems.

### SUMMARY OF THE INVENTION

An access method for a wireless authentication login system that allows a user to login to a system via a wireless authentication device is provided, in order to improve upon the conventional methods of verifying a user's identification using usernames and access codes.

An embodiment according to the access method includes: the wireless authentication device enters the effective range of an authentication module of the system; the authentication module of the system senses the wireless authentication device and sends an access request message; the authentication module transmits an authentication request message to the wireless authentication device; the authentication module receives a set of access codes from the wireless authentication device; an authentication procedure is processed, and lastly the user is given access to the system.

The preferred embodiment of the access method for a wireless authentication login system includes: the wireless authentication device that a user possesses enters the effective range of an authentication module of the system; the authentication module of the system senses the wireless authentication device and sends an access request message accordingly; the authentication module transmits an authentication request message to the wireless authentication device; the authentication module receives a set of access codes from the wireless authentication device; the set of access codes is compared with the user's information, in order to judge whether the correspondence between the wireless authentication device and the authentication module is valid; being sure of the validity of the correspondence between the wireless authentication device and the authentication module establishing a wireless connection between the two devices; lastly, the user is given access to the system.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which would form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a conventional login page;

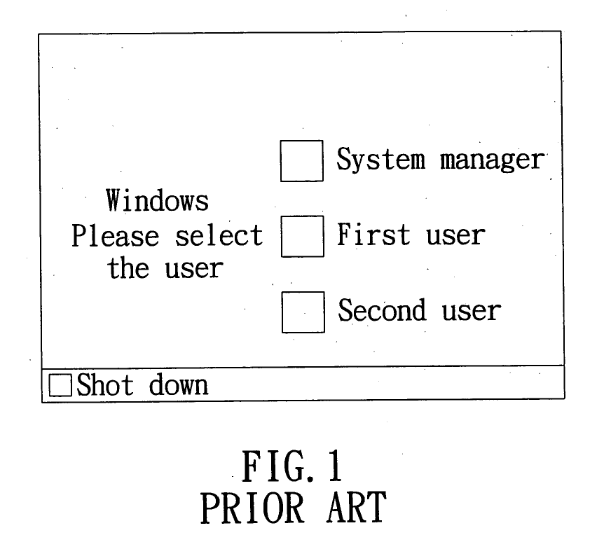

FIG. 2 is a perspective view of an access method for a wireless authentication login system according to the present invention;

FIG. 3 is a diagram of the access method for a wireless authentication login system according to the present invention;

FIG. 4 is a login flow chart of the access method for a wireless authentication login system according to the present invention;

FIG. 5 is a login flow chart of a preferred embodiment of the access method for a wireless authentication login system according to the present invention; and

FIG. 6 is a logout flow chart of the access method for a wireless authentication login system according to the present invention.

### DETAILED DESCRIPTION OF PREFERRED EMBODIMENTS

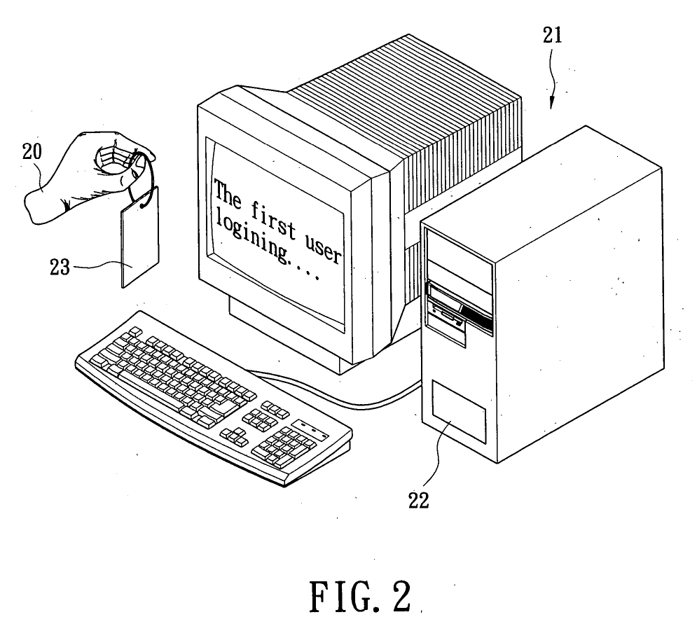

An access method for a wireless authentication login system that allows a user to login to a system via a wireless authentication device is provided. With respect to FIG. 2, a user 20 wears or holds a wireless authentication device 23 and is close to a computer host 21. The wireless authentication device 23 couples with an authentication module 22 installed in the computer host 21 in an inductive or an electromagnetic manner, thereby providing an authentication procedure. In accordance with the authentication procedure, the computer host 21 provides corresponding access codes and user information. After the provided information is judged to be valid, the computer host 21 can be accessed without requiring the user to input/select their username or input their access codes.

The authentication module 22 of the computer host 21 can be either an attached or built-in module, and further embedded to an identification IC chip on a motherboard of the computer host 21. The wireless authentication device 23 can be an active or a passive RFID, a card with a bar code, a magnetic card or an embedded device of a similar nature, which is unrestrained by the embedded devices. The wireless authentication device 23 includes a wireless module that communicates by wireless methods, bluetooth radio, IrDA or laser, in order to couple with the authentication module 22 in an inductive or an electro-magnetic mauler.

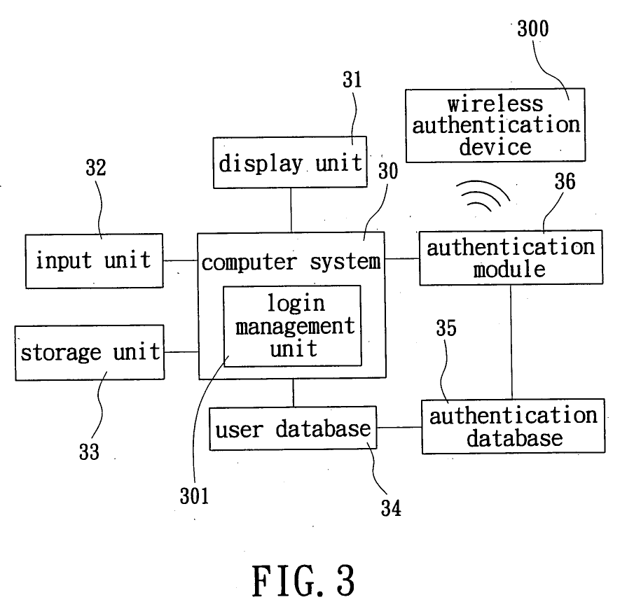

A diagram of the access method for a wireless authentication login system according to the present invention is illustrated in FIG. 3. The computer host can be a local or a remote computer host. A computer system 30 includes a display unit 31 to show a login frame, a login status or an error/success message; an input unit 32, such as a mouse or a keyboard; and a storage unit 33, such as a hard disk or a soft disk, as a medium for saving information, which is protected by the access method according to the present invention, in the computer system 30.

The computer system 30 further includes a users' information in a multi-user system in a user database 34, for example usernames, access codes, data files thereof, and an operating system. An authentication module 36 according to the present invention can be attached to or built into the computer system 30, or embedded as part of a printed circuit board arranged inside the computer system 30. When a wireless authentication device 300 approaches within a certain range of the authentication module 36 of the computer system 30, the wireless authentication device 300 couples with the authentication module 36 in an inductive or an electro-magnetic manner, so as to verify a user's identity. This step will be treated as an authentication request message by the computer system 30. A set of access codes from the wireless authentication device 300 is then received by the authentication module 36; after successfully connecting between an authentication database 35 and the user database 34, a wireless connection between the wireless authentication device 300 and the authentication module 36 is established. Lastly, the computer system 30 is logged into after the method for comparing and matching the users' information is completed by a login management unit 301 of the computer system 30. The method is used instead of the conventional method without requiring the user to input their username or access code.

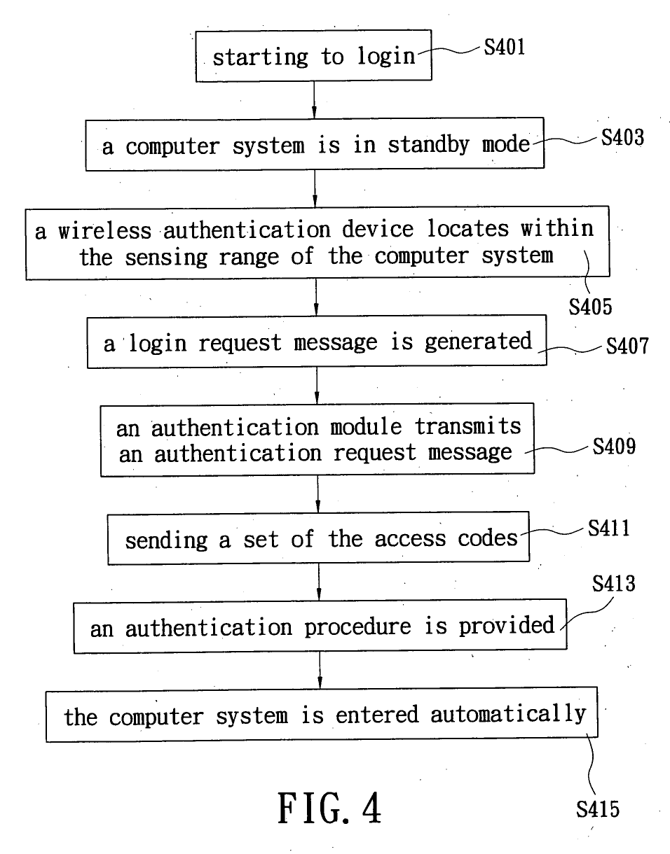

The steps of the access method described in FIG. 4 include: before establishing a login status, an authentication module of a computer system should provide a wireless connection and an identification relationship with a wireless authentication device that a user possesses, the relationship can be a public key or a private key and allows a user to access information stored on the computer system, such as on a lookup table. It further allows a wireless connection that allows access to information on an individual or a group basis. Step S401: a login process starts after the wireless connection is established. Step S403: the computer system is in standby mode at the beginning of the procedure waiting to locate a wireless authentication device inside its sensing range. Step S405: the wireless authentication device connects to an authentication module of the computer system when located within the sensing range of the computer system. Step S407: a login request message is generated after the authentication module senses the wireless authentication device and informs the computer system. Step S409: the authentication module transmits an authentication request message requesting access codes from the wireless authentication device. Step S411: after that, the wireless authentication device sends a set of access codes to the authentication module. Step S413: an authentication procedure is provided; the set of access codes is compared with the user's information, and the codes can be encoded into predetermined codes; the set of access codes and the user's information are judged for their validity; if the codes are invalid, the computer system goes back to standby mode or gives a warning message showing an access error has occurred; if both the codes and the information are valid, a wireless connection is established between the wireless authentication device and the authentication module is established. Step S415: lastly, the user is given access to the system.

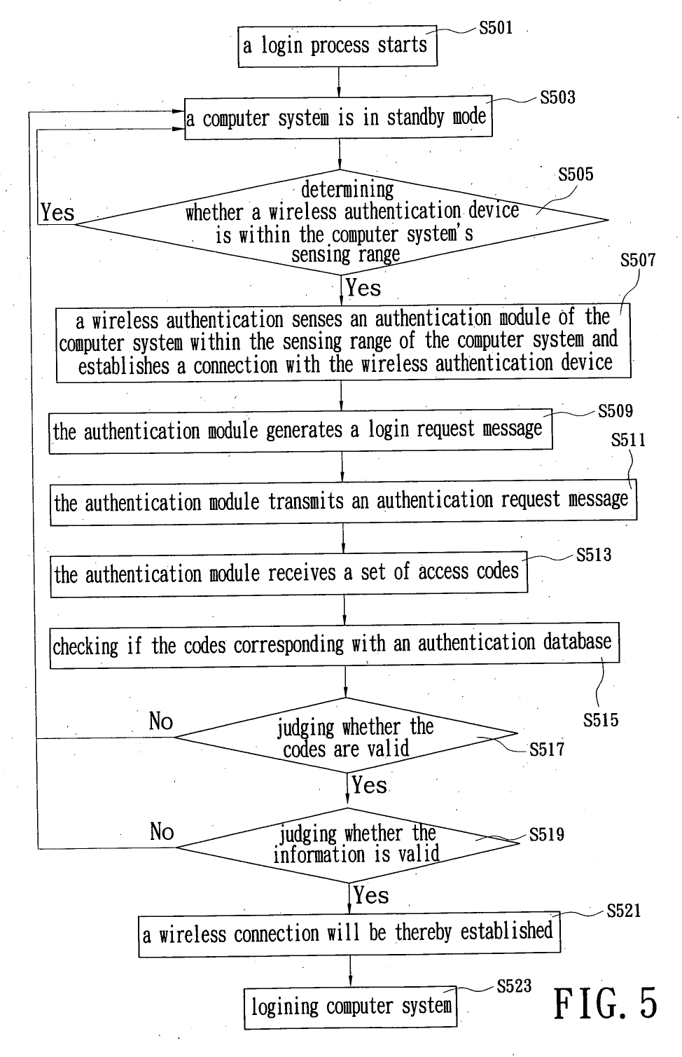

Referring to FIG. 5, a preferred embodiment of the method according to the present invention is illustrated. A wireless connection and identification procedure with a wireless authentication device that a user possesses must be established before the system is accessed. In this preferred embodiment the computer system is a multi-user system. Step S501: a login process begins once a wireless connection is established. Step S503: the computer system is in standby mode, which detects if the wireless authentication device enters within the sensing range. Step S505: determining whether a wireless authentication device is within the computer system's sensing range, if there are no such devices within this sensing range the computer system remains in standby mode. Step 9507: the wireless authentication device senses an authentication module of the computer system within the sensing range of the computer system and establishes a connection with the wireless authentication device; for example, a user holds the wireless authentication device and enters the effective range of the authentication module of the computer system. Step S509: a login request message is generated after the authentication module senses the wireless authentication device and informs the computer system. Step S511: the authentication module transmits an authentication request message. Step S513: the wireless authentication device transmits the access codes embedded in a chip thereof and the authentication module receives them. Step S515: an authentication procedure is provided by the authentication module, which includes the access codes and an authentication database with the user's corresponding information. Step S517: judging whether the codes are valid, and judging whether the set of access codes from the wireless authentication device are recorded in the authentication database after comparing the access codes with the user's information. If the codes do not correspond to those stored in the authentication database, the computer system cannot be accessed, a warning message will inform the user that an error occurred in the procedure and the computer system will return to standby mode. The authentication database may be encrypted for further security. Step S519: judging whether the information is recorded in the authentication database accurately. If the user's information does not correspond to the information stored in the authentication database, the computer system cannot be accessed, a warning message will inform the user that an error occurred in the procedure and the computer system will return to standby mode. According to this embodiment, an error status occurs if the user's information does not correspond to the codes, the computer system goes back to the initial standby status. Step S521: if there are no errors between the wireless authentication device and the authentication module, a wireless connection will be thereby established. The computer system can check whether the connection is valid at predetermined intervals. Step S523: if the connection is valid, and the user has access to the information, the computer system will allow the user to view or access the predetermined page.

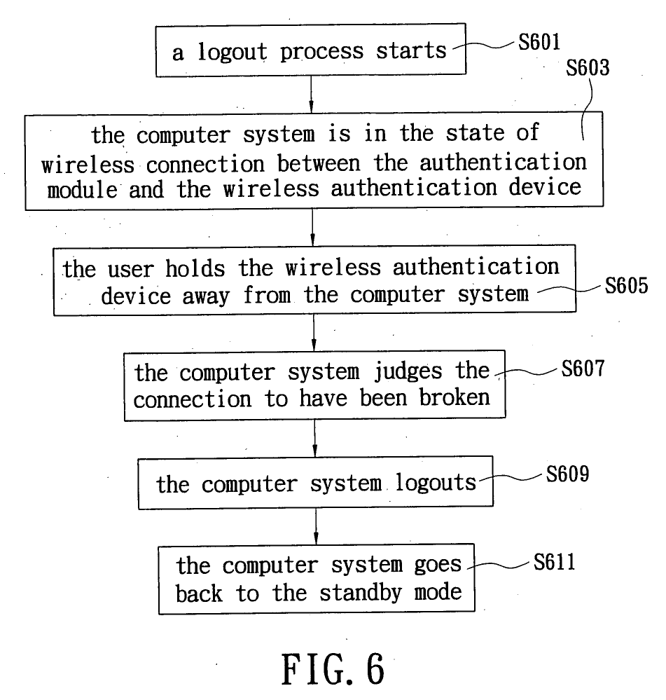

FIG. 6 illustrates a logout process according to an embodiment of the present invention. As soon as the connection is broken, maybe because the authentication module breaks down or the wireless authentication device becomes damaged, or the user takes the wireless authentication device outside of the computer system's sensing range, the authentication procedure terminates and the logout process must begins in step S601. In Step S603, the computer system is still connected with the authentication module and the wireless authentication device. In step S605, the user holds the wireless authentication device away from the computer system. In step S607 the computer system judges the connection to have been broken. In Step S609, the computer system automatically logouts. The computer system returns to standby mode and awaits the next approaching event in Step S611.

According to the present invention, the access method for a wireless authentication login system can be used instead of the conventional steps of username selection and access codes.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An access method for a wireless authentication login system that allows a user to login to a computer system via a wireless authentication device, the access method comprising:
entering within a sensing range of the computer system, wherein the wireless authentication device enters the sensing range of an authentication module of the computer system;
generating an access request message, wherein the authentication module of the computer system senses the wireless authentication device within the sensing range and generating the access request message;
transmitting an authentication request message, wherein the authentication module transmits the authentication request message to the wireless authentication device;
receiving a set of access codes, wherein the authentication module receives the set of access codes from the wireless authentication device;
processing an authentication procedure; and
logging into the computer system.

2. The access method as claimed in claim 1, wherein before the wireless authentication device enters the sensing range of the computer system, the computer system is in a standby mode, which also detects if the wireless authentication device enters within the sensing range.

3. The access method as claimed in claim 1, wherein the computer system is a multi-user operation computer system.

4. The access method as claimed in claim 1, wherein the step of getting within the sensing range of the computer system, the wireless authentication device includes a wireless module to couple with the authentication module in an inductive or an electromagnetic manner.

5. The access method as claimed in claim 1, wherein the computer system is a local or a remote computer host.

6. The access method as claimed in claim 1, wherein the step of processing an authentication procedure further includes:
comparing the set of access codes with the user's information;
judging whether the set of access codes is valid;
judging whether the user's information is valid; and
providing a wireless connection relationship between the wireless authentication device and the authentication module.

7. The access method as claimed in claim 6, further including a logout procedure if the wireless connection is invalid.

8. The access method as claimed in claim 6, wherein the computer system returns to standby mode if the set of access codes is invalid.

9. The access method as claimed in claim 6, further providing a warning message showing an access error has occurred if the user's information is invalid.

10. The access method as claimed in claim 6, wherein the computer system goes back to standby mode if the set of access codes is invalid.

11. The access method as claimed in claim 6, further providing a warning message showing an access error has occurred if the set of access codes is invalid.

12. An access method for a wireless authentication login computer system comprising:
entering within an sensing range of the computer system, wherein the wireless authentication device that a user possesses enters the sensing range of an authentication module of the computer system;
generating an access request message, wherein the authentication module of the computer system senses the wireless authentication device and generating the access request message;
transmitting an authentication request message, wherein the authentication module transmits the authentication request message to the wireless authentication device;
receiving a set of access codes, wherein the authentication module receives the set of access codes from the wireless authentication device;
comparing the set of access codes with a user's information;
judging whether the set of access codes is valid;
judging whether the user's information is valid;
providing a wireless connection relationship between the wireless authentication device and the authentication module; and
logging into the computer system.

13. The access method as claimed in claim 12, wherein before entering into the sensing range of the computer system, the computer system is in standby mode, which also detects if the wireless authentication device enters within the sensing range.

14. The access method as claimed in claim 12, wherein the computer system is a multi-user operation computer system.

15. The access method as claimed in claim 12, further including a logout procedure if the wireless connection relationship is invalid.

16. The access method as claimed in claim 12, wherein the computer system goes back to standby mode while the set of access codes is invalid.

17. The access method as claimed in claim 12, further providing a warning message showing an access error has occurred if the user's information is invalid.

18. The access method as claimed in claim 12, wherein the computer system goes back to standby mode if the set of access codes is invalid.

19. The access method as claimed in claim 12, wherein in the step of entering into the sensing range of the computer system, the wireless authentication device includes a wireless module to couple with the authentication module in an inductive or an electro-magnetic manner.
